(19) United States
(12) Patent Application Publication
(10) Pub. No.: US 2008/0043425 A1
(43) Pub. Date: Feb. 21, 2008

(54) Methods and systems for cooling a computing device

(76) Inventors: Justin Richard Hebert, Spring, TX (US); Stephen J. Higham, Houston, TX (US); Daniel G. Parsons, Magnolia, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/506,331

(22) Filed: Aug. 17, 2006

(51) Int. Cl. G06F 1/20

(52) U.S. Cl. 361/687

(57) ABSTRACT

Various technologies for cooling a computer system are described. A computer system includes an enclosure having a number of vents distributed across different portions of the enclosure to provide different thermal pathways to transfer heat to air surrounding the computer system. The computer system is configured to be operable under different orientations. The enclosure is designed such that when the computer system is operating under a particular orientation, then at least one or more of the thermal pathways is able to transfer heat to air surrounding the computing system. Also, a processor and optionally a chipset reside within an interior region of the enclosure. A first cooling assembly is thermally coupled to the processor to cool the processor. Optionally, a second cooling assembly is thermally coupled to the chipset to cool the chipset.

### TECHNICAL FIELD

Embodiments generally relate to methods and systems for cooling a computing device.

### BACKGROUND

Due to the advancement in the computer industry, computing devices (e.g., personal computers) have been getting smaller in size and the same time generating more heat. In order to maintain a computing device being operated under a working temperature, a cooling mechanism is frequently utilized to facilitate efficient cooling of the computing device.

However, for certain categories of computing devices, such as thin client devices, a cooling mechanism that uses moving parts are not desirable because it raises noise and reliability concerns. As a result, a common way of cooling, such as using a fan, is often not pursued.

Moreover, in order to meet various business demands, it is often desired that a computing device (e.g., a thin client device) is designed to be operable under different orientations. In one example, a user may place a thin client device horizontally on his or her desk. In another example, a user may mount a thin client device vertically on a wall. In yet another example, a user may attach a thin client device to the rear side of a computer monitor. Unfortunately, conventional cooling mechanisms often cannot adapt to different orientations and can only function properly when a computing device is situated in a default orientation.

### SUMMARY

This Summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Various technologies for cooling a computer system are described. In accordance with one described embodiment, a computer system includes an enclosure having a number of vents distributed across different portions of the enclosure to provide different thermal pathways to transfer heat to air surrounding the computer system. The computer system is configured to be operable under different orientations. For example, the computer system can operate while placed horizontally on a desk or mounted vertically on a wall.

The enclosure is designed such that when the computer system is operating under a particular orientation, then at least one or more of the thermal pathways is able to transfer heat to air surrounding the computing system.

The computer system also includes a first divider and a second divider that reside within the enclosure. The first divider and the second divider define a first region, a second region, and a third region. The third region is between the first region and the second region. Also, a processor and optionally a chipset reside within the third region of the enclosure.

A first cooling assembly is thermally coupled to the processor. The first cooling assembly includes a first heat sink for transferring heat from the processor to surrounding air and a first heat pipe thermally coupled to the first heat sink to facilitate the transfer of heat from the first heat sink to a set of fins residing within the first region.

Optionally, a second cooling assembly is thermally coupled to the chipset. The second cooling assembly includes a second heat sink for transferring heat from the chipset to surrounding air and a second heat pipe thermally coupled to the chipset to facilitate the transfer of heat from the second heat sink to a another set of fins residing within the second region.

In this way, embodiments allow a computer system to be efficiently cooled while it operates under different orientations. Moreover, embodiments accomplish this without using a cooling mechanism that includes moving parts, such as a fan. As a result, the computer system is more reliable and essentially noise free.

### BRIEF DESCRIPTION OF THE DRAWINGS

FIG. 1 illustrates a computing device, in accordance with an embodiment of the present claimed subject matter.

FIG. 2 illustrates two thermal pathways directing heat away from a computing device, in accordance with an embodiment of the present claimed subject matter.

FIG. 3 illustrates two thermal pathways directing heat through a perforated surface and away from a computing device, in accordance with an embodiment of the present claimed subject matter.

FIG. 4 illustrates a top view of a first cooling assembly and a second cooling assembly, in accordance with an embodiment of the present claimed subject matter.

FIG. 5 illustrates a perspective view of a first cooling assembly and a second cooling assembly, in accordance with an embodiment of the present claimed subject matter.

FIG. 6 illustrates four thermal pathways that direct heat away from a first cooling assembly and a second cooling assembly, in accordance with an embodiment of the present claimed subject matter.

FIG. 7 illustrates copper inserts for a first cooling assembly and a second cooling assembly, in accordance with an embodiment of the present claimed subject matter.

FIG. 8 illustrates two thermal pathways directing heat away from a computing device placed in a horizontal position, in accordance with an embodiment of the present claimed subject matter.

FIG. 9 illustrates two thermal pathways directing heat through a number of vents and away from a computing device placed in a horizontal position, in accordance with an embodiment of the present claimed subject matter.

FIG. 10 illustrates three thermal pathways directing heat away from a mounted computing device, in accordance with an embodiment of the present claimed subject matter.

FIG. 11 illustrates three thermal pathways directing heat away from a mounted computing device (with an angular differential of 180 degrees than the computing device in FIG. 10), in accordance with an embodiment of the present claimed subject matter.

FIG. 12 illustrates a thermal pathway directing heat through and away from a perforated portion of a mounted computing device, in accordance with an embodiment of the present claimed subject matter.

FIG. 13 illustrates three thermal pathways directing heat away from a computing device mounted on a flat screen display, in accordance with an embodiment of the present claimed subject matter.

FIG. 14 illustrates a flowchart for cooling a computing device upon which embodiments in accordance with the present claimed subject matter can be implemented.

FIG. 15 illustrates a flowchart for forming a computing device upon which embodiments in accordance with the present claimed subject matter can be implemented.

### DETAILED DESCRIPTION OF THE DRAWINGS

Reference will now be made in detail to embodiments of the present claimed subject matter, examples of which are illustrated in the accompanying drawings. While the claimed subject matter will be described in conjunction with these embodiments, it will be understood that they are not intended to limit the claimed subject matter to these embodiments. On the contrary, the claimed subject matter is intended to cover alternatives, modifications and equivalents, which may be included within the spirit and scope of the claimed subject matter as defined by the appended claims. Furthermore, in the following detailed description of the present claimed subject matter, numerous specific details are set forth in order to provide a thorough understanding of the present claimed subject matter. However, it will be evident to one of ordinary skill in the art that the present claimed subject matter may be practiced without these specific details. In other instances, well known methods, procedures, components, and circuits have not been described in detail as not to unnecessarily obscure aspects of the claimed subject matter.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. A procedure, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of usage, to refer to these signals as bits, bytes, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present claimed subject matter, discussions utilizing terms such as “setting,” “storing,” “scanning,” “receiving,” “sending,” “disregarding,” “entering,” or the like, refer to the action and processes of a computer system or similar electronic computing device, that manipulates and transforms data represented as physical (electronic) quantities within the computer system's registers and memories into other data similarly represented as physical quantities within the computer system memories or registers or other such information storage, transmission or display devices.

For certain types of computing devices, such as thin client devices, a cooling mechanism that uses moving parts is not desirable because it increases noise level and reduces reliability. This is due in part to that fact that thin client devices are often deployed in places where reliability and low noise level is of paramount importance. For instance, thin clients are often deployed in financial centers, banking centers, administrative centers, call centers, medical centers, and various kiosks. The importance of reliability, for example, in a financial center is self evident as a crash caused by a failure in the cooling mechanism can lead a serious transaction error. Furthermore, since a user of a thin client device is often situated in close proximity to the thin client device, a high noise level can irritate the user and lead to decreased productivity.

In response to the above described issues as well as other concerns, embodiments describe various technologies for efficiently cooling a computer system. In one example, an embodiment illustrates a cooling mechanism that does not require the use of a fan or other types of moving parts. Also, in another example, the cooling mechanism is flexible and can adapt to different physical orientations of the computer system. As such, a computer system is efficiently cooled whether it is in a vertical position, a horizontal position, or a mounted position.

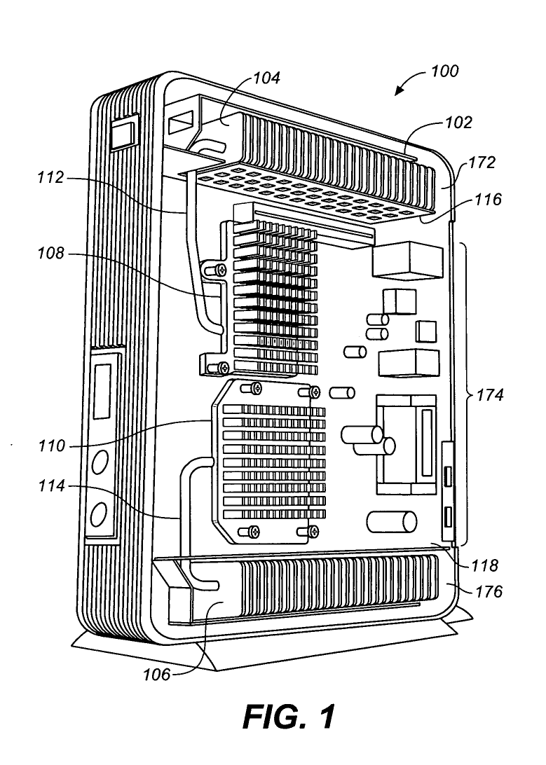

FIG. 1 illustrates a computing device 100, in accordance with an embodiment of the present claimed subject matter. Computing device 100 includes an enclosure 102, remote fins 104, remote fins 106, first heat sink 110, second heat sink 108, first heat pipe 114, second heat pipe 112, first divider 118, and second divider 116. Also, the computing device 100 includes a processor (not shown in FIG. 1) and a chipset (not shown in FIG. 1). The processor resides within the enclosure 102 and is located underneath the first heat sink 110. The chipset (e.g., a northbridge and southbridge chipset) resides within the enclosure 102 and is located underneath the second heat sink 108. Also, although computing device 100 is shown and described as having certain numbers and types of elements, the present claimed subject matter is not so limited; that is, computing device 100 may include elements other than those shown, and may include more than one of the elements that are shown. For example, computing device 100 can include additional cooling mechanisms. Further, although computing device 100 is illustrated under the present arrangement of elements, embodiments are not limited to the present arrangement of elements illustrated in FIG. 1.

With reference still to FIG. 1, the enclosure 102 has a number of vents distributed across different portions of the enclosure to provide different thermal pathways to transfer heat to air surrounding the computing device 100. The vents, in one example, are evenly spaced circular perforations. In another example, the vents can be other types of perforations (e.g., rectangular perforations) distributed across the enclosure.

Also, the computing device 100 is configured to be operable under different orientations (e.g., mounted on the rear portion of a flat screen, placed horizontally on a desk, or positioned vertically on a desk). The computing device 100 is designed such that when the computing device 100 is operating under a particular orientation, then at least one or more of the available thermal pathways is able to transfer heat to air surrounding the computing device 100.

Additionally, a first divider 118 and a second divider 116 reside within the enclosure 102 to define a first region 176, a second region 172, and a third region 174. A function served by the first divider 118 is to create a thermal wall between the first region 176 and the third region 174 such that the heat being dissipated by remote fins 106 residing within the first region 176 does not flow back towards the third region 174. By having the first divider 118, heat dissipated by the remote fins 106 residing within the first region 176 is more effectively directed away from the computing device 100.

Similarly, a function served by the second divider 116 is to create a thermal wall between the second region 172 and the third region 174 such that the heat being dissipated by remote fins 104 residing within the second region 172 does not flow back towards the third region 174. By having the second divider 116, heat dissipated by the remote fins 104 residing within the first region 176 is more effectively directed away from the computing device 100.

The processor and the chipset (both not shown) reside within the third region 174 of the enclosure 102. A first cooling assembly (e.g., heat sink and heat pipe) is thermally coupled to the processor. The first cooling assembly includes the first heat sink 110 for transferring heat from the processor to surrounding air and the first heat pipe 114 thermally coupled to the first heat sink 110 to facilitate the transfer of heat from the first heat sink 110 to remote fins 106. Remote fins 106 reside within the first region 174. In one embodiment, the first heat pipe 114 is appropriately curved such that the processor and the remote fins 106 are substantially parallel with respect to each other. In one embodiment, the first heat pipe 114 includes a metal weave interior for conducting heat. In another embodiment, the first heat pipe 114 includes a copper enclosure with a wicking structure for transferring liquid (e.g., water).

Optionally, a second cooling assembly (e.g., heat sink and heat pipe) is thermally coupled to the chipset. The second cooling assembly includes a second heat sink 108 for transferring heat from the chipset to surrounding air and a second heat pipe 112 thermally coupled to the chipset to facilitate the transfer of heat from the second heat sink 108 to remote fins 104. Remote fins 104 reside within the second region 172.

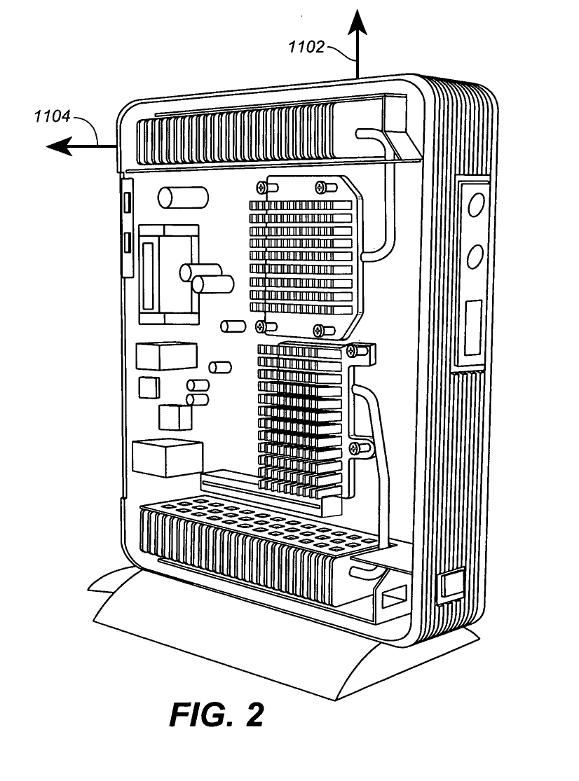

FIG. 2 illustrates a first thermal pathway 1102 and a second thermal pathway 1104 from which heat can be transferred from the computing device 100 into the surrounding air. The first thermal pathway 1102 transfers heat in a perpendicular direction away from the computing device 100. The second thermal pathway 1104 transfers heat away from the computing device 100 in a direction that is parallel to the vertical axis of the computing device 100.

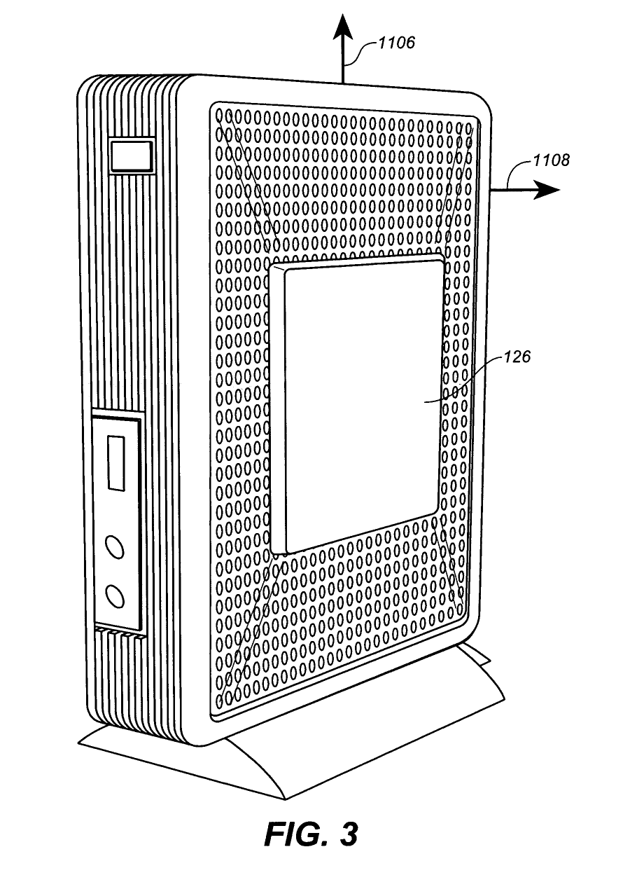

FIG. 3 illustrates a view of the computing device where the enclosure 102 includes a perforated portion 126 that allows heat to escape. In one embodiment, the perforated portion 126 is made of metal which has evenly spaced circular perforations. While the computing device 100 is in this orientation, heat can be dissipated at least via thermal pathway 1108 and thermal pathway 1106. With thermal pathway 1108, heat flows perpendicularly through the perforated portion 126 and away from the interior region of the computing device 100. With thermal pathway 1106, heat flows in a direction parallel to the vertical axis of the computing device 100, through the vent on the top portion of the enclosure 102 (not shown in FIG. 3), and away from the computing device 100.

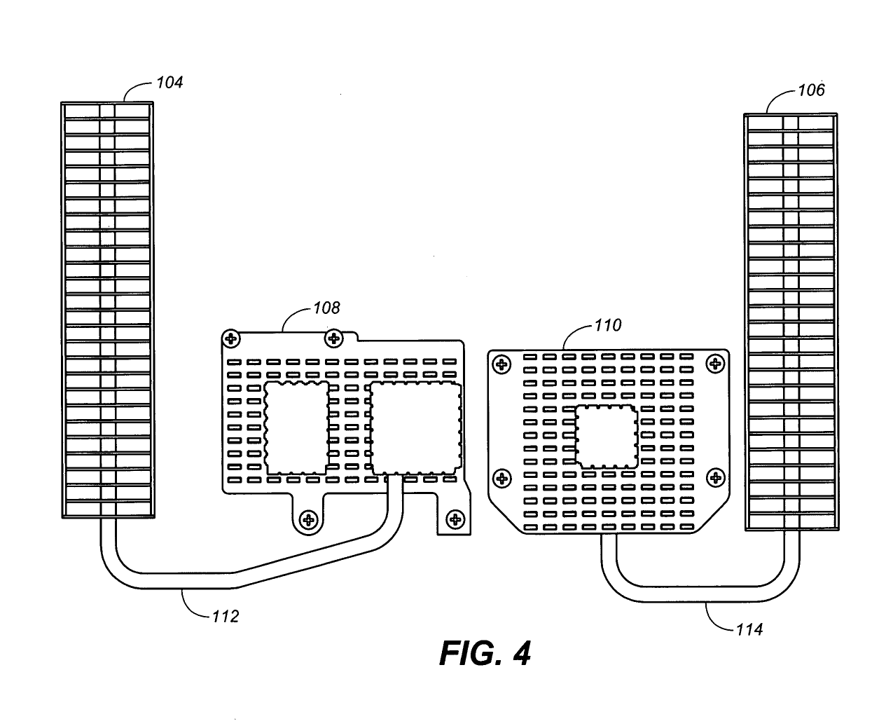

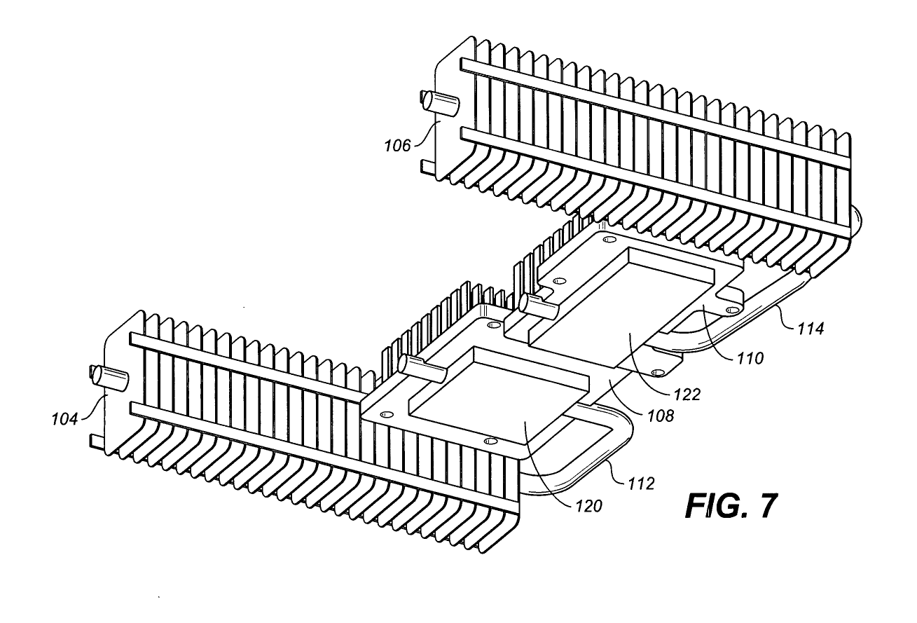

A more detailed view of the remote fins 104, remote fins 106, first heat sink 110, second heat sink 108, first heat pipe 114, and second heat pipe 112 are shown in FIG. 4. The first heat sink 110 is thermally coupled with a processor and the second heat sink 108 is thermally coupled with a chipset, such as a northbridge and southbridge chipset. In one embodiment, the first heat sink 110 is thermally coupled with the processor via a copper insert 122 (shown in FIG. 7). Similarly, in another embodiment, the second heat sink 108 is thermally coupled with the chipset via a copper insert 120 (shown in FIG. 7).

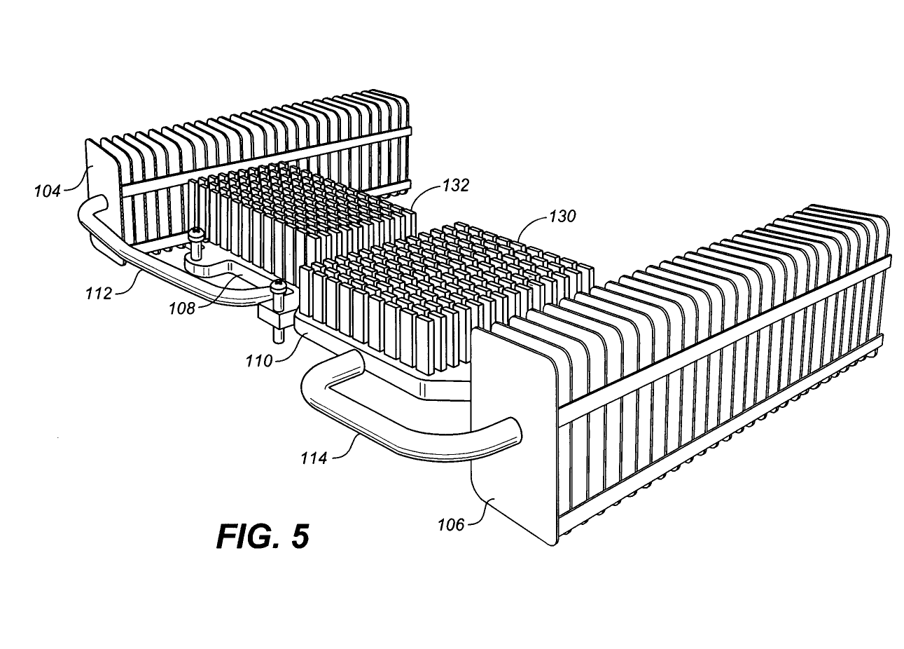

When thermally coupled, the first heat sink 110 absorbs heat from the processor. The absorbed heat is dissipated in at least two ways. First, the first heat sink 110 dissipates the absorbed heat into surrounding air via a number of heat sink fins 130 (illustrated in FIG. 5). Second, the first heat pipe 114 transfers heat from the first heat sink 110 to remote fins 106 (e.g., aluminum fins). Remote fins 106 then dissipate the heat into surrounding air.

Likewise, when thermally coupled, the second heat sink 108 absorbs heat from the chipset. The absorbed heat is dissipated in at least two ways. First, the second heat sink 108 dissipates the absorbed heat into surrounding air via a number of heat sink fins 132 (illustrated in FIG. 5). Second, the second heat pipe 112 transfers heat from the second heat sink 108 to remote fins 104 (e.g., aluminum fins). Remote fins 104 then dissipate the heat into surrounding air.

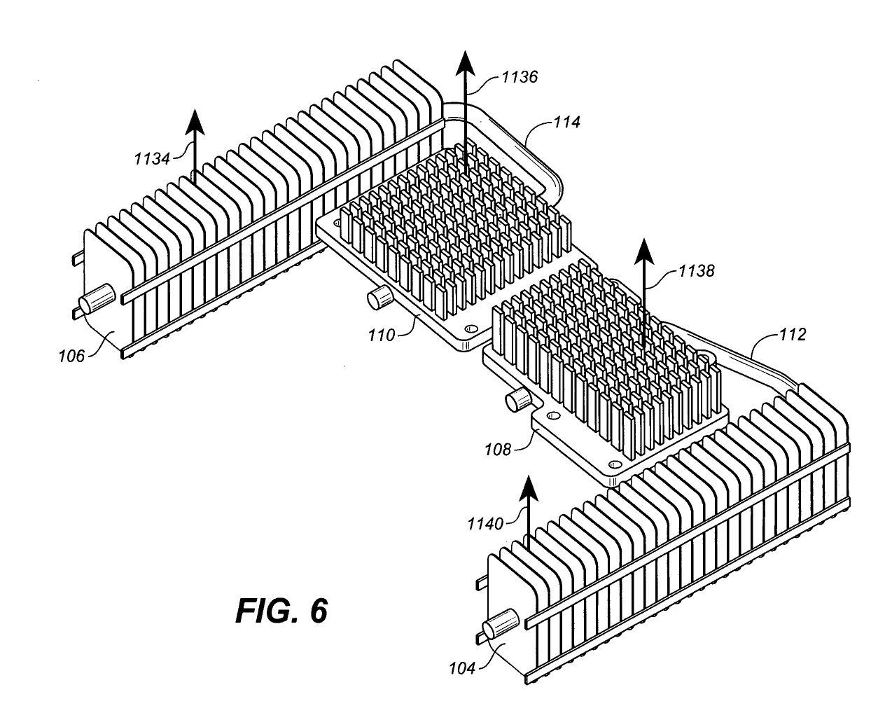

FIG. 6 illustrates a perspective view of how heat can be dissipated. FIG. 6 shows thermal pathway 1134, thermal pathway 1136, thermal pathway 1138, and thermal pathway 1140. Specifically, thermal pathway 1134 transfers heat from remote fins 106 into surrounding air; thermal pathway 1136 transfers heat from heat sink 110 into surrounding air; thermal pathway 1138 transfers heat from heat sink 108 into surrounding air; and thermal pathway 1140 transfer heat from remote fins 104 into surrounding air.

In this manner, embodiments describe at least two approaches for cooling the processor and the chipset. Also, the first heat pipe 114 and/or the second heat pipe 112 can be a sintered heat pipe. In one embodiment, the sintered heat pipe comprises a copper enclosure with a wicking structure for transferring a fluid (e.g., water). The fluid is utilized to move heat from one location of the heat pipe to another location of the heat pipe. In particular, with reference to the present claimed subject matter, a fluid within a heat pipe is used to transfer the heat from a processor towards a number of heat dissipating fins.

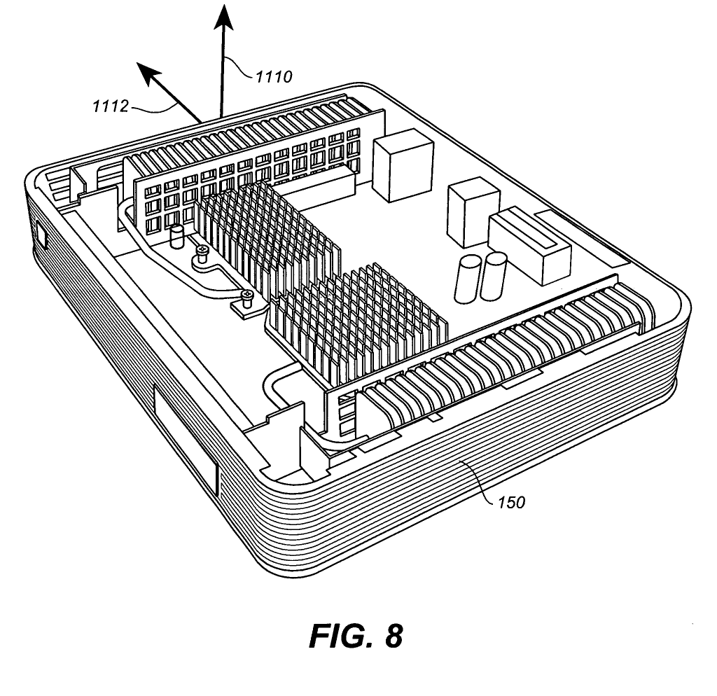

Furthermore, as stated above, an advantage of the present claimed subject matter is that the cooling mechanism is flexible and can adapt to different physical orientations of the computer device 100. As such, the computer system 100 is efficiently cooled whether it is in a vertical position, a horizontal position, or a mounted position. To illustrate, FIG. 8 shows how the computing device 100 in a horizontal position is efficiently cooled. FIG. 8 shows thermal pathways 1110 and 1112 from which heat can be dissipated. Specifically, heat can rise and travel vertically away from computing device 100 via thermal pathway 1110. Also, heat can dissipate through a side vent, such as vent 150, and be transferred into surrounding air via thermal pathway 1112.

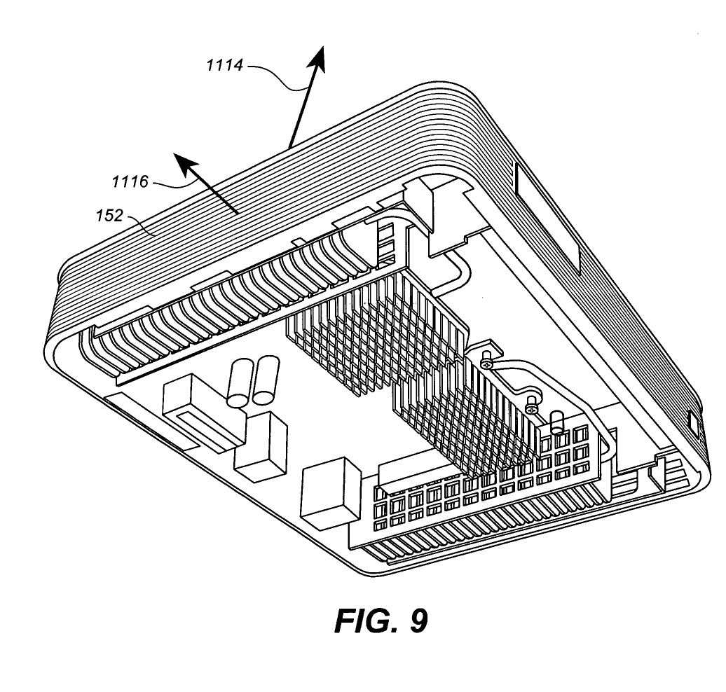

FIG. 9 shows the computing device 100 in a different horizontal position. In contrast to FIG. 8, where the heat sink 110 is facing up, FIG. 9 shows the computing device 100 with the heat sink 110 facing down. Here, heat is dissipated via thermal pathways 1114 and 1116. Thermal pathway 1116 transfers heat from the computing device 100 through vent 152 to the surrounding air. Thermal pathway 1114 transfers heat from the computing device 100 through a top portion of the enclosure that is perforated (not shown in FIG. 9).

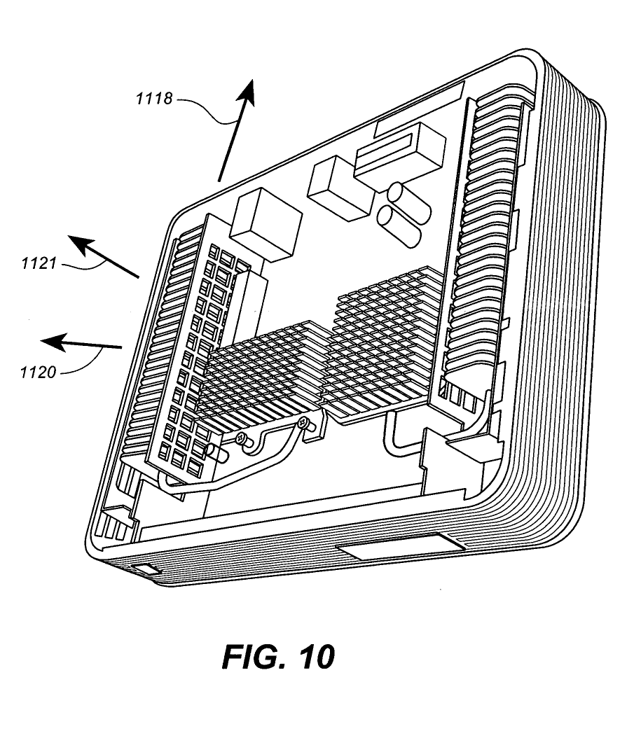

FIG. 10 illustrates the computing device 100 in a mounted position. Thermal pathways 1118, 1121, and 1120 transfer the heat from the computing device 100 into the surrounding air. In one example, thermal pathways 1118, 1121, and 1120 essentially form right angles with one another. In other words, thermal pathways 1118, 1121, and 1120 are generally orthogonal with one another.

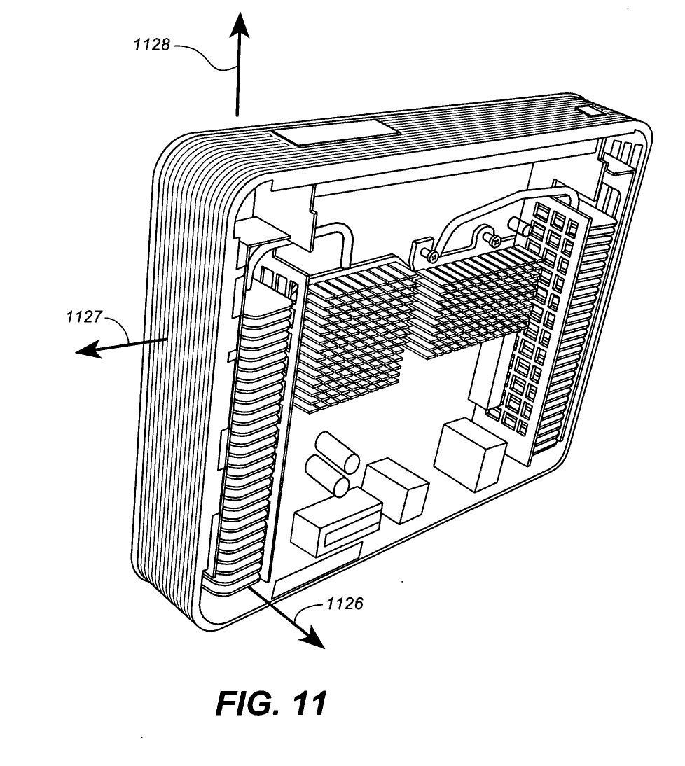

FIG. 11 shows computing device 100 in a different mounted position. Specifically, the orientation of computing device 100 shown in FIG. 11 differs from the orientations of computing device 100 shown in FIG. 10 by 180 degrees. In other words, a 180 degree rotation of computing device 100 shown in FIG. 10 around an imaginary axis that is perpendicular to the wall would place it in the same orientation as the computing device 100 shown in FIG. 11.

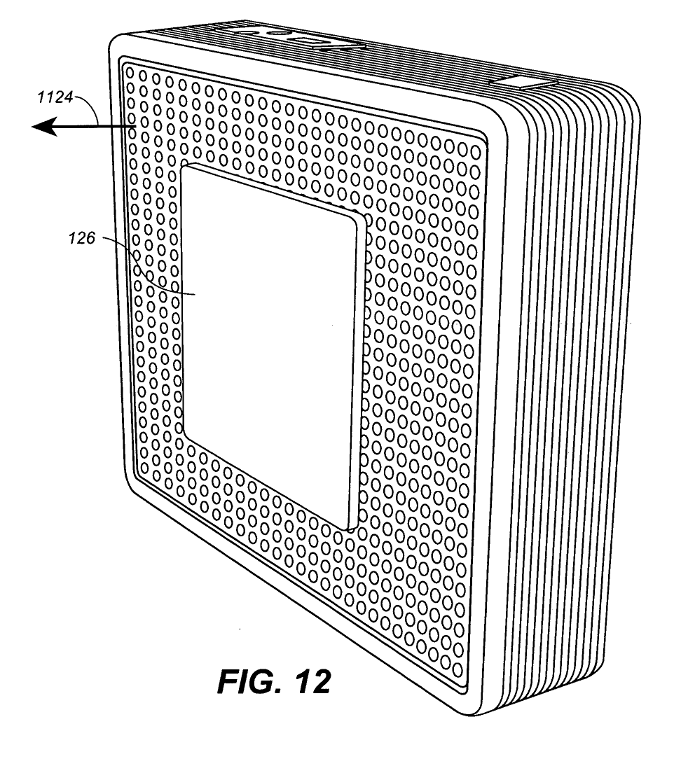

Similarly, FIG. 11 illustrates thermal pathways 1126, 1127, and 1128 that transfer the heat from the computing device 100 into the surrounding air. FIG. 12 illustrates a computing device 100 with a perforated portion 126. The perforations on perforated portion 126 allow heat to be dissipated via thermal pathway 1124.

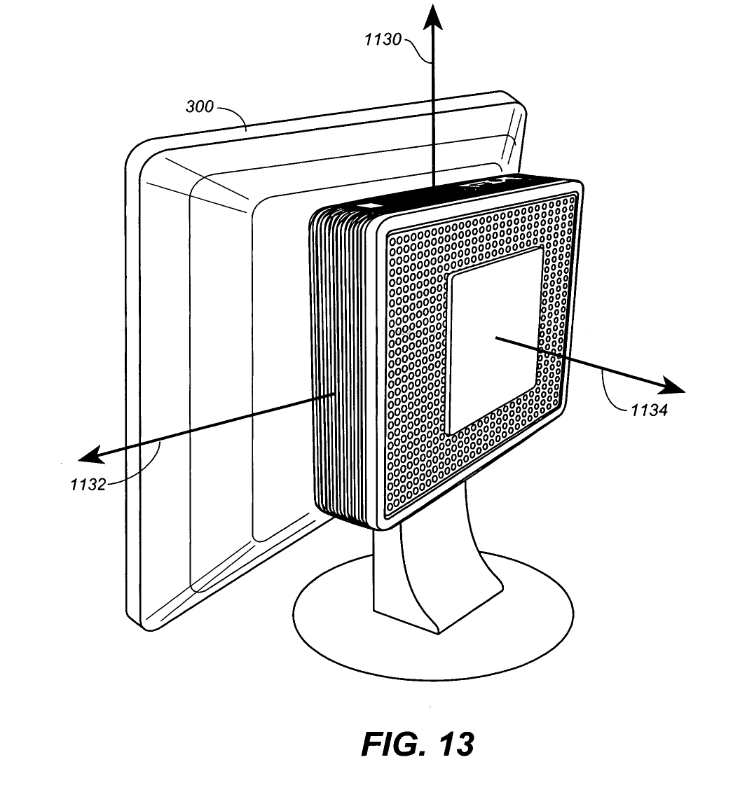

FIG. 13 illustrates computing device 100 mounted on the rear portion of a flat screen display 300. While in this mounted position, heat can be dissipated at least via thermal pathways 1130, 1132, and 1134. Thermal pathways 1130, 1132, and 1134 may form substantially right angles with one another.

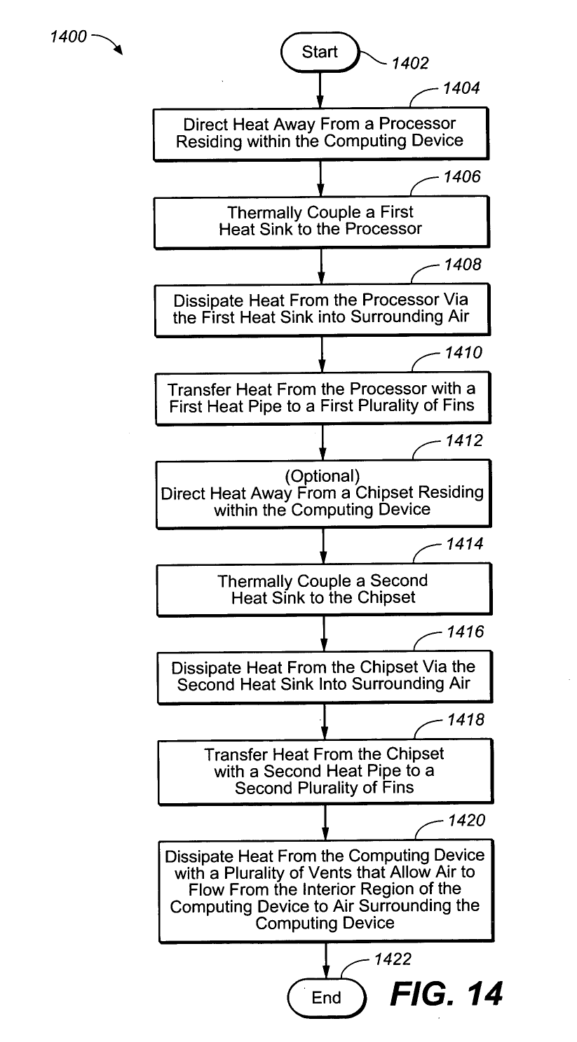

FIG. 14 illustrates a flowchart 1400 for cooling a computing device 100 upon which embodiments in accordance with the present claimed subject matter can be implemented. Although specific steps are disclosed in flowchart 1400, such steps are exemplary. That is, embodiments of the present claimed subject matter are well suited to performing various other or additional steps or variations of the steps recited in flowchart 1400. It is appreciated that the steps in flowchart 1400 can be performed in an order different than presented. At block 1402, the process starts.

At block 1404, heat is directed away from a processor (e.g., central processing unit) residing within the computing device 100. In particular, heat is directed away from the processor in at least the ways described in block 1408 and 1410. At block 1406, a first heat sink 110 is thermally coupled to the processor. In one embodiment, the first heat sink 110 has a plurality of evenly spaced aluminum fins (e.g, heat sink fins 130). The spacing between the aluminum fins is calculated to maximize heat dissipation. Also, in one embodiment, the first heat sink 110 is attached to the processor via a copper insert 122. Further, the first heat sink 110 can be made of different types of thermal conductors other than copper and aluminum. For example, gold and silver are efficient thermal conductors.

At block 1408, heat from the processor is dissipated via the first heat sink 110 into surrounding air. In one example, the copper insert 122 is in thermal contact with the processor and absorbs heat from the processor. The absorbed heat is then dissipated by the plurality of fins (e.g., heat sink fins 130).

At block 1410, heat from the processor is transferred with a first heat pipe 114 to a first plurality of remote fins 106. In this way, the first heat pipe 114 provides another way of dissipating the heat from the first heat sink 110. The plurality of remote fins 106, in one example, includes an array of rectangular aluminum fins that dissipate heat efficiently.

Also, in one embodiment, the first heat sink 110 is coupled with a thermal pad and the thermal pad is in physical contact with a chassis of the computing device 100. In this way, heat from the first heat sink 110 is directed into the chassis, which dissipates heat into surrounding air.

At block 1412 (optional step), heat is directed away from chipset residing within the computing device 100. Again, heat is directed away from the chipset in at least two ways described in block 1416 and 1418. At block 1414, a second heat sink 108 is coupled to the chipset. At block 1416, heat from the second heat sink 108 is dissipated into surrounding air. At block 1418, heat from the second heat sink 108 is transferred with the second heat pipe 112 into a second plurality of remote fins 104.

At block 1420, heat from the computing device 100 is dissipated with a plurality of vents (e.g., vent 152 of FIG. 9) that allow air to flow from the interior region of the computing device 100 to air surrounding the computing device 100. The vents, in one example, are evenly spaced perforations (e.g., circular perforations) that are distributed on multiple sides of the computing device 100. In one example, as vents exist on all sides of a computing device 100, the computing device 100 can be placed in different orientations without blocking off airflow. At block 1422, the process ends.

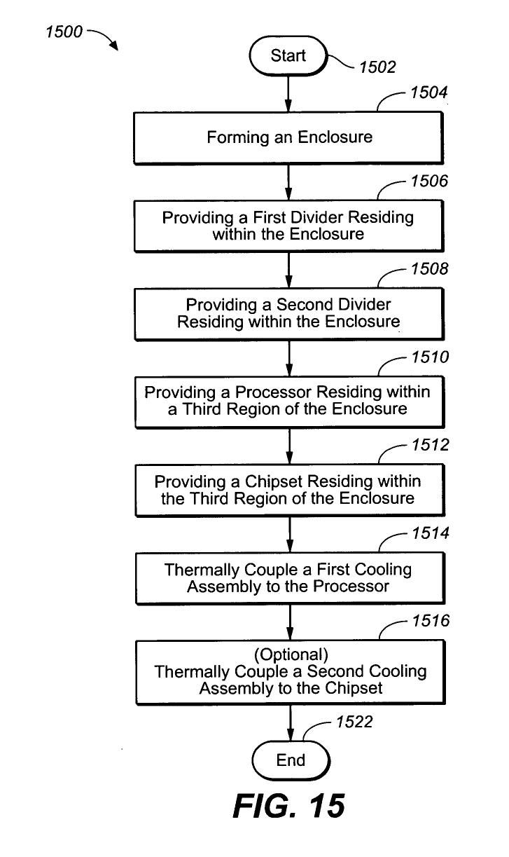

FIG. 15 illustrates a flowchart 1500 for forming a computing device 100 upon which embodiments in accordance with the present claimed subject matter can be implemented. Although specific steps are disclosed in flowchart 1500, such steps are exemplary. That is, embodiments of the present claimed subject matter are well suited to performing various other or additional steps or variations of the steps recited in flowchart 1500. It is appreciated that the steps in flowchart 1500 can be performed in an order different than presented. At block 1502, the process starts.

At block 1504, an enclosure 102 is formed. In one embodiment, the enclosure 102 is designed such that if the computing device 100 is operating under a particular orientation, then at least one or more of the thermal pathways is able to transfer heat to air surrounding the computing device 100.

At block 1506, a first divider 118 (e.g., a perforated plate) residing within the enclosure 102 is provided. At block 1508, a second divider 116 residing within the enclosure 102 is provided. The first divider 118 and the second divider 116 define a first region 176, a second region 172, and a third region 174. The third region 174 (e.g., an interior region) is between the first region 176 and the second region 172. Also, a processor and a chipset reside within the third region 174 of the enclosure 102.

At block 1510, a processor residing within the third region 174 of the enclosure 102 is provided. At block 1512, a chipset residing within the third region 174 of the enclosure 102 is provided.

At block 1514, a first cooling assembly is thermally coupled to the processor. The first cooling assembly includes a first heat sink 110 for transferring heat from the processor to surrounding air and a first heat pipe 114 thermally coupled to the first heat sink 110 to facilitate the transfer of heat from the first heat sink 110 to a set of remote fins 106 residing within the first region 176. A key purpose of the first divider 118 is to create a thermal wall between the first region 176 and the third region 174 such that the heat being dissipated by the set of remote fins 106 residing within the first region 176 does not flow back towards the third region 174. By having the first divider 118, heat dissipated by the set of remote fins 106 residing within the first region 176 is more effectively directed away from the computing device 100.

At block 1516, optionally, a second cooling assembly is thermally coupled to the chipset. The second cooling assembly includes a second heat sink 108 for transferring heat from the chipset to surrounding air and a second heat pipe 112 thermally coupled to the chipset to facilitate the transfer of heat from the second heat sink 108 to a another set of remote fins 104 residing within the second region 172. At block 1522, the process ends.

Embodiments describe various technologies, such as different methods and systems, which allow a computing device 100 to be efficiently cooled while it operates under different orientations (e.g., vertical position, horizontal position, mounted position). Moreover, embodiments accomplish this without using a cooling mechanism that includes moving parts, such as a fan. As a result, an end user is able to position the computing device 100 (e.g., a thin client computer) in different orientations without paralyzing the cooling mechanism. Furthermore, because the cooling mechanism does not utilize moving parts, the computing device 100 benefits from increased reliability and reduced noise level.

In the foregoing specification, embodiments have been described with reference to numerous specific details that may vary from implementation to implementation. Thus, the sole and exclusive indicator of what is, and is intended by the applicants to be the claimed subject matter is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer system, comprising:
an enclosure having a plurality of vents distributed across different portions of said enclosure to provide a plurality of thermal pathways to transfer heat to air surrounding said computer system, wherein said computer system is configured to be operable under a plurality of orientations, wherein when said computer system is operating under any orientation of said plurality of orientations, then at least one or more of said plurality of thermal pathways is able to transfer heat to air surrounding said computing system;
a first divider residing within said enclosure;
a second divider residing within said enclosure, wherein said first divider and said second divider define a first region, a second region, and a third region, and wherein said third region is between said first region and said second region;
a processor residing within said third region of said enclosure; and
a first cooling assembly thermally coupled to said processor, comprising:
a first heat sink for transferring heat from said processor to surrounding air; and
a first heat pipe thermally coupled to said first heat sink to facilitate the transfer of heat from said first heat sink to a first plurality of fins, wherein said first plurality of fins reside within said first region.

2. The computer system of claim 1, further comprising:
a chipset residing within said third region of said enclosure; and
a second cooling assembly thermally coupled to said chipset, comprising:
a second heat sink for transferring heat from said chipset to surrounding air; and
a second heat pipe thermally coupled to said second heat sink to facilitate the transfer of heat from said second heat sink to a second plurality of fins, wherein said second plurality of fins reside within said second region.

3. The computer system of claim 2, wherein said chipset comprises a northbridge and a southbridge.

4. The computer system of claim 1, wherein said computer system is a thin client device.

5. The computer system of claim 1, wherein said first divider is a perforated plate.

6. The computer system of claim 1, said first heat sink further comprising:
a plurality of aluminum heat dissipating fins spaced from each other; and
a copper insert.

7. The computer system of claim 1, wherein said first heat pipe is a sintered heat pipe.

8. The computer system of claim 1, further comprising:
a thermal pad coupled with said first cooling assembly to sink heat into said enclosure.

9. The computer system of claim 1, wherein said first plurality of fins dissipate heat from said first heat pipe via a first thermal pathway and a second thermal pathway, wherein said first thermal pathway comprises airflow that is generally parallel to said first plurality of fins, and wherein said second thermal pathway comprises airflow that is generally perpendicular to said first plurality of fins.

10. The computer system of claim 1, wherein said plurality of vents comprises evenly spaced perforations.

11. The computer system of claim 1, wherein each fin of said first plurality of fins has a generally rectangular shape.

12. The computer system of claim 1, wherein said first heat pipe is appropriately curved such that said processor and said first plurality of fins are substantially parallel with respect to each other.

13. The computer system of claim 1, wherein said first heat pipe includes a metal weave interior for conducting heat.

14. A computer system, comprising:
an enclosure means having a plurality of vents distributed across different portions of said enclosure means to provide a plurality of thermal pathways to transfer heat to air surrounding said computer system, wherein said computer system is configured to be operable under a plurality of orientations, wherein when said computer system is operating under any orientation of said plurality of orientations, then at least one or more of said plurality of thermal pathways is able to transfer heat to air surrounding said computing system;
a first divider means residing within said enclosure;
a second divider means residing within said enclosure, wherein said first divider means and said second divider means define a first region, a second region, and a third region, wherein said third region is between said first region and said second region;
a processor means residing within said third region of said enclosure means; and
a first cooling assembly means thermally coupled to said processor, comprising:
a first heat sink means for transferring heat to surrounding air; and
a first heat pipe means thermally coupled to said first heat sink means to facilitate the transfer of heat from said first heat sink means to a first plurality of fins, wherein said first plurality of fins reside within said first region.

15. The computer system of claim 14, further comprising:
a chipset means residing within said third region of said enclosure; and
a second cooling assembly means thermally coupled to said chipset means, comprising:
a second heat sink means for transferring heat to surrounding air; and
a second heat pipe means thermally coupled to said second heat sink means to facilitate the transfer of heat from said second heat sink means to a second plurality of fins, wherein said second plurality of fins reside within said second region.

16. A method of manufacturing a computing system, said method comprising:
forming an enclosure having a plurality of vents distributed across different portions of said enclosure to provide a plurality of thermal pathways to transfer heat to air surrounding said computer system, wherein said computer system is configured to be operable under a plurality of orientations, wherein when said computer system is operating under any orientation of said plurality of orientations, then at least one or more of said plurality of thermal pathways is able to transfer heat to air surrounding said computing system;
providing a first divider residing within said enclosure;
providing a second divider residing within said enclosure, wherein said first divider and said second divider define a first region, a second region, and a third region, wherein said third region is between said first region and said second region;
providing a processor residing within said third region of said enclosure; and
thermally coupling a first cooling assembly to said processor, said first cooling assembly comprising:
a first heat sink for transferring heat to surrounding air; and
a first heat pipe thermally coupled to said first heat sink to facilitate the transfer of heat from said first heat sink to a first plurality of fins, wherein said plurality of fins reside within said first region.

17. The method of claim 16, further comprising:
providing a chipset residing within said third region of said enclosure; and
thermally coupling a second cooling assembly to said chipset, said second cooling assembly comprising:
a second heat sink for transferring heat to surrounding air; and
a second heat pipe thermally coupled to said second heat sink to facilitate the transfer of heat from said second heat sink to a second plurality of fins, wherein said plurality of fins reside within said second region.

18. A method for cooling a computing device, said method comprising:
directing heat away from a processor residing within said computing device, comprising:
thermally coupling a first heat sink to said processor, wherein a first heat pipe is coupled with said first heat sink, and wherein said first heat pipe is coupled with a first plurality of fins;
dissipating heat from said processor via said first heat sink into surrounding air; and
transferring heat from said processor with said first heat pipe to said first plurality of fins, wherein said first plurality of fins dissipate the transferred heat into surrounding air; and
dissipating heat from said computing device with a plurality of vents that allow air to flow from the interior region of said computing device to air surrounding said computing device.

19. The method of claim 18, further comprising:
directing heat away from a chipset residing within said computing device, comprising:
thermally coupling a second heat sink to said chipset, wherein a second heat pipe is coupled with said second heat sink, and wherein said second heat pipe is coupled with a second plurality of fins;
dissipating heat from said chipset via said second heat sink into surrounding air; and
transferring heat from said chipset with said second heat pipe to said second plurality of fins, wherein said second plurality of fins dissipate the transferred heat into surrounding air.

20. The method of claim 18, wherein said computing device is configured to be operable under a plurality of orientations, and wherein said plurality of vents are positioned on various regions of said computing device as to allow proper ventilation while said computing device is operating under any of said plurality of orientations.

21. The method of claim 18, wherein said first heat pipe comprises a copper enclosure with a wicking structure for transferring liquid.

22. The method of claim 18, wherein said computing device is operable at least under a vertical position, a horizontal position, and a mounted position.

23. The method of claim 18, wherein said computing device comprises a top surface, a bottom surface, a right surface, a left surface, a front surface, and a rear surface, wherein a number of said plurality of vents are distributed on said top surface, wherein a number of said plurality of vents are distributed on said bottom surface, wherein a number of said plurality of vents are distributed on said right surface, wherein a number of said plurality of vents are distributed on said left surface, wherein said front surface comprises a first plurality of perforations, and wherein said rear surface comprises a second plurality of perforations.

24. The method of claim 18, further comprising:
thermally coupling said first heat sink to a thermal pad, wherein said thermal pad is in thermal contact with a chassis of said computing device, wherein heat from said first heat sink is directed into said chassis, and wherein said chassis dissipates heat into surrounding air.
